(19) United States
(12) Patent Application Publication
(10) Pub. No.: US 2011/0320250 A1
(43) Pub. Date: Dec. 29, 2011

(54) ADVERTISING PRODUCTS TO GROUPS WITHIN SOCIAL NETWORKS

(75) Inventors: David J. Gemmell, Danville (CA); Min-John Lee, Santa Cruz, CA (US); Ashok Chandra, Saratoga, CA (US); Vincent Vergonjeanne, Paris (FR); Emre M. Kiciman, Seattle, WA (US)

(73) Assignee: Microsoft Corporation, Redmond, WA (US)

(21) Appl. No.: 12/823,609

(22) Filed: Jun. 25, 2010

(51) Int. Cl. G06Q 30/00

(52) U.S. Cl. 705/14.16; 705/319; 705/14.1

(57) ABSTRACT

Within a social network, users may form social groups based on shared traits, such as experiences and interests. The social network may be able to detect a user interest among the users of a social group in one or more products offered by one or more vendors (e.g., by evaluating conversations within the social group and search queries executed by users of the social group), and to notify the vendors of the detected user interest. The vendors may be willing to extend an offer to the users of the social group regarding the product, and the social network may present the offer to the users of the social group. The social network may also track acceptances of the offer by users of the social group, and may provide an e-commerce infrastructure to allow users to complete purchases of the product and to provide the rewards featured in the offers.

### BACKGROUND

Within the field of computing, many scenarios involve aspects of social networking, wherein users may establish associations representing relationships with other users, and may share data of interest with all or some associated users. In this context, a user may establish a social profile comprising data that identifies various aspects of the user to associated users, such as demographic information, a set of interests such as hobbies or professional skills, and a set of resources that are interesting to the user. Users may consent to having some aspects of his or her social profile shared; e.g., a user might generate a message (such as a personal status, a note about a particular topic, or a message directed to another user) that may initially be accessible only to users who are associated with the user, but may permit an associated user to repost the message for access by all of the users associated with the associated user (e.g., a friend of a user may be permitted to take the user's message and repost it to grant access to the friend's friends.) In this manner, data shared over a social network (and, in particular, data comprising the social profile of a user) may be propagated in select ways to others via the social network. Many social networks also allow users to form social groups associated with particular topics, such as a shared set of experiences (e.g., the members of a school class) or interests (e.g., a particular product, product vendor, or product area.)

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

The rich set of information represented within a social network, and particularly within the social profiles of users, associations among users, and the formation of social groups, may facilitate the advertising and targeting of products to users. In particular, vendors of products may present product offers to the users of various social groups that are highly targeted for the product. For example, the social network may detect user interest in a product among the users of a social group, such as by monitoring conversations among the users that relate to the product, product reviews of the product generated by the users, and search queries executed by the users that relate to the product. When an interested user group is detected, a vendor of the product may be notified, and may consent to the presentation of an offer to the user group relating to the product. The offer may be contingent upon many types of actions, e.g., testing or purchasing the product, influencing other users of the social network to test or purchase the product, or posting a user review of the product, and may involve many types of rewards, e.g., a discounted price or rebate on the product, an improved version of the product (such as an extended warranty or a device with more storage capacity), or an award of virtual currency conferring value within the social network. The social network may advertise the offer to the users of the social group in various ways, e.g., by notifying the user of the offer to the social group within an advertisement for the product, or by notifying the user of other users of the social network who have purchased the product. The social network may also be configured to detect a redemption of the offer by a user of the social group, and to provide the reward to the user on behalf of the vendor. The social network may also track the influence of users upon other users within the social network, and may present to the user a social influence profile indicating the effects of the user's actions on other users of the social network (such as the effectiveness of the user's product reviews.) In these and other ways, the social network and the information represented therein may be utilized to promote the sale of products and services among the users of various social groups.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary scenario featuring a set of users communicating and forming social groups within a social network.

FIG. 2 is an illustration of an exemplary scenario featuring the advertising of a product by a vendor to a social group comprising at least two users of a social network in accordance with the techniques presented herein.

FIG. 3 is a flowchart illustrating an exemplary method of promoting a product to a social group comprising at least two users of a social network.

FIG. 4 is a component block diagram illustrating an exemplary system for promoting a product to a social group comprising at least two users of a social network.

FIG. 5 is an illustration of an exemplary computer-readable medium comprising processor-executable instructions configured to embody one or more of the provisions set forth herein.

FIG. 6 is an illustration of an exemplary scenario featuring a cascading reward offered by a vendor to a social group.

FIG. 7 is an illustration of an exemplary scenario featuring an advertisement of a product to a user personalized with an offer for the social group of the user.

FIG. 8 is an illustration of an exemplary scenario featuring a comparison of offers from a vendor pertaining to a product and a recommendation of a selected offer.

FIG. 9 is an illustration of an exemplary scenario featuring a presentation of an influence profile of a user on other users of a social group regarding a product.

FIG. 10 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

Within the field of computing, many scenarios involve a social network, wherein users may generate a personal representation in the form of a social profile, such as a set of personal descriptors of the user's identity, academic and professional background, and personal interests. Users may also form associations with other users of the social network, where such associations may represent familial relationships, friendships, acquaintanceships, academic and professional connections, and shared interests. The user may also consent to share the contents of the social profile with the associated users, either by affirmatively inviting an associated user to view a particular data item or by simply granting such other users access to the social profile, and may view the social profiles of the associated users. The users of the social network may also communicate through the delivery of various types of messages, such as private messages sent to one or more associated users or public messages that are shared with all of the associated users.

The users of the social network may also form various types of social groups, may represent, e.g., a set of users having a shared experience (such as the students of an academic class) or a shared interest (such as an appreciation for a particular genre of music), a social clique (such as a highly interconnected set of users), or an organization. The social groups may also be open (wherein anyone may join) or closed (wherein a user may be admitted only with the consent of the current members of the group), public or private, and may be hierarchically or anarchically organized (with or without defined leadership or roles.) In particular, a social group may comprise a set of users having a shared interest in a product, the products of a vendor, or a product area. The users of the social group may share data items that may be of interest to other users of the social group (e.g., links to product reviews or news articles relating to new or current products), and may engage in various conversations relating to such topics.

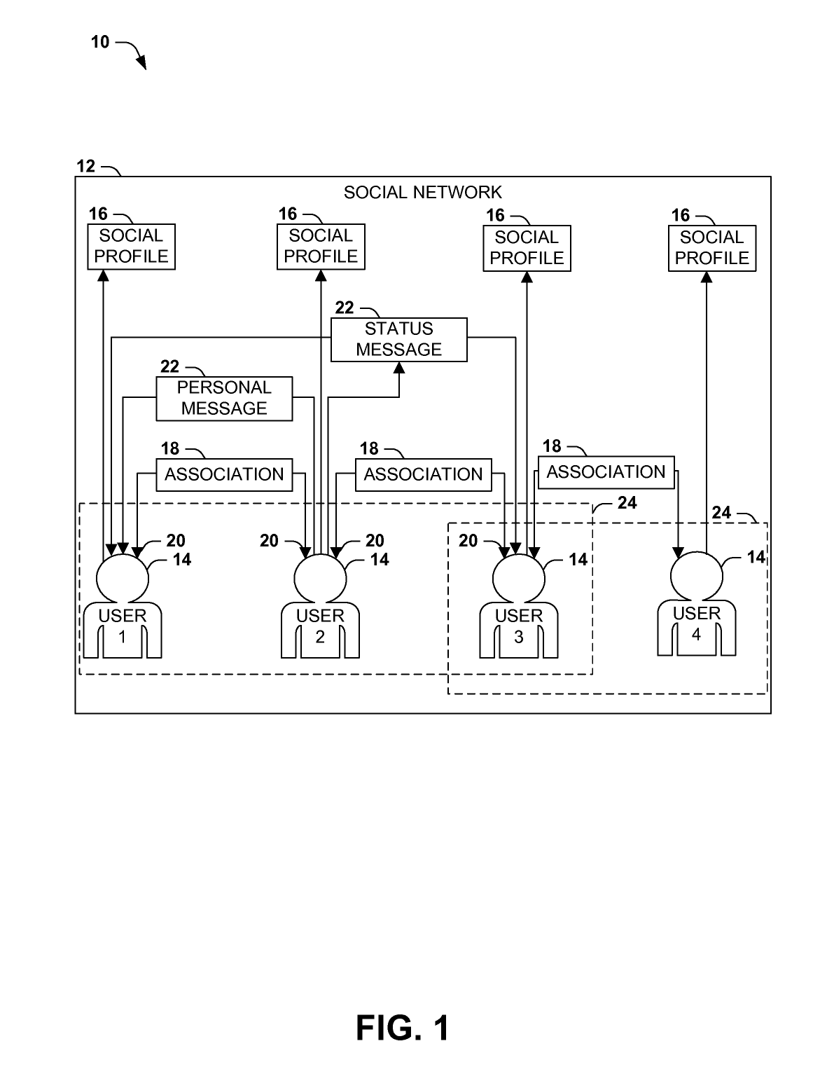

FIG. 1 presents an exemplary scenario 10 featuring a social network 12 comprising a set of users 14. Within the social network 12, each user 14 may create a social profile 16, such as a set of data items that describe the demographic information, academic and professional skills, and interests of the user 14. The users 14 may also establish associations 18 with other users 14, where such associations 18 may represent various types of relationships, such as familial connections, friendships, acquaintanceships, past or present academic or professional associations, shared interests, or joint membership in a group. A user 14 may therefore establish associations 18 with a set of associated users 20, representing the social connections of the user 14 within the social network 12, and may permit the associated users 20 to view some or all of the social profile 16 of the user 12. For example, within the exemplary scenario 10 of FIG. 1, a second user 12 may establish associations 18 with a set of associated users 20 including a first user 14 and a third user 14 of the social network 12, but may not have an association 18 with a fourth user 14 of the social network 12 who has an association 18 with the third user 14. Accordingly, the social profile 16 of the second user 14 may be accessible to the first user 14 and the third user 14 as associated users 20 of the second user 14, but may not be accessible to the fourth user 14. Additionally, users 14 may form social groups 24, such as a first social group 24 comprising the first user 14, the second user 14, and the third user 14, and a second social group 24 comprising the third user 14 and the fourth user 14. These social groups 24 may be hierarchical (e.g., associating particular roles with different users 14, such as an administrator or leader of the social group 24) or anarchical, and may either permit any user 14 of the social network 12 to join or may admit users 14 only upon the consent of one or more current users 14 of the social group 24.

Also within the field of computing, many scenarios involve the advertisement of products to users 14 (e.g., through advertisements delivered via a network such as in websites or media broadcasts, or through applications that may be executed online or offline upon devices of the user 14.) These advertisements may occasionally be targeted to the user 14, e.g., by accessing demographic information associated with the user (such as the user's age, gender, and location) and presenting product advertisements that are generally persuasive for users 14 having such demographics. As a first example, a vendor of a product may choose to place advertisements in several websites, and for each website, may identify the demographics of typical visitors and may choose an advertisement for each website that is persuasive to viewers having such demographics. As a second example, a communication service, such as an email host or a chat network, may monitor communications involving a particular user 14, may identify one or more topics of conversation involving the user, and may present to the user 14 advertisements for products that are related to such topics. In these and other ways, advertisers may achieve improved effectiveness (such as ensuing product purchases) in response to the presented advertisements.

Presented herein are techniques for extending the opportunities and effectiveness of targeted advertising by utilizing the information represented in the social network 12. In particular, the membership of various users 14 in various social groups 24 may provide an opportunity for targeted advertising to the social group 24 based on the traits shared among the users 14 of the social group 24. For example, a social group 24 may be formed to discuss a particular product 24, a particular vendor of one or more products 24, or a particular product area, such as the field of mobile communication devices. The social network 12 may facilitate the marketing of products to these social groups 24 by detecting the user interests of the social group 24, as may be expressed, e.g., in the types of data items shared among the users 14 of the social group 24, in the conversations among the users 14 of the social group 24, and in the search queries executed within the social network 12 by the users 14 of the social group 24. Upon detecting a user interest among the users 14 of the social group 24 in a particular product or product area, the social network 12 may notify a vendor of the product. The vendor may then wish to make an offer relating to the product to the users 14 of the social group 24, such as a price discount or rebate for the product or an improved version of the product (such as included accessories or an extended service warranty), and the social network 12 may present the offer to the users 14. In this manner, the social network 12 may assist the vendor with the marketing of its products to social groups 24 that may be interested in such products, and may convey valuable offers to the users 14 of the social network 12.

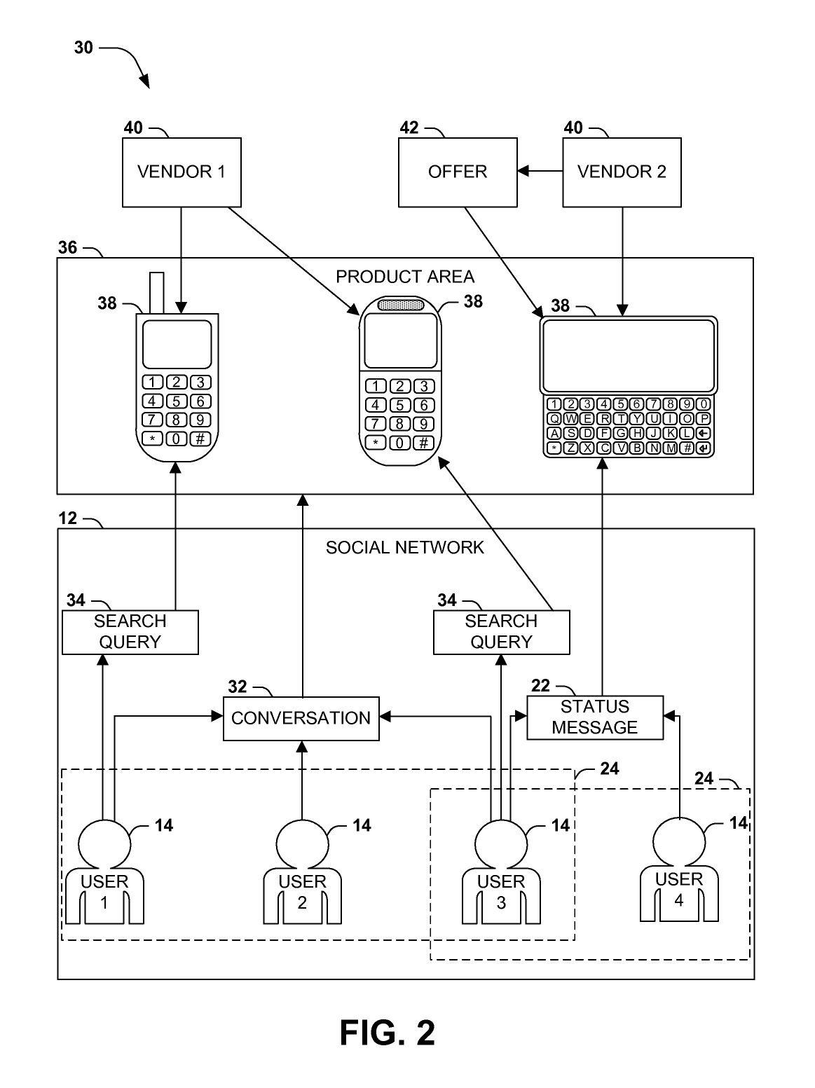

FIG. 2 presents an exemplary scenario 30 featuring a social network 12 comprising users 14 of a social network 12 who may choose to form one or more social groups 24, such as a first social group 24 comprising a first user 14, a second user 14, and a third user 14 and a second social group 24 comprising the third user 14 and a fourth user 14. The users 14 of a social group 24 may exchange many types of messages, such as directed messages 22 to other users 14, personal status messages 22, and comments comprising a conversation 32 about a topic. Additionally, the users 14 may perform other types of activities, such as performing search queries 34 for various topics that may be discussed within the social network 12. In particular, the messages 22, conversations 32, and search queries 34 may relate to a product 38 (e.g., questions, comments, user reviews or user ratings, product recommendations, or product recommendation requests), to a vendor 40 of a product (e.g., comments about the typical quality of products and customer service offered by a vendor 40), and/or to a product area 40 (e.g., requests for a recommendation of a product 38 among the products 38 comprising a product area 40, such as mobile communication devices.) The social network 12 may monitor these communications among the users 14 of the social groups 24, and may endeavor to detect when the messages and activities by the users 14 indicate a user interest in a product 38 among the members of respective social groups 24. Upon detecting a user interest of a social group 24 in a product 38, the social network 12 may then notify the vendor 40 of the user interest within the social group 24. The vendor 40 may then choose to present an offer 42 to the social group 24, e.g., a discount or rebate on the purchase of the product 38. The social network 12 may receive the offer 42 from the vendor 40 and present it to the users 14 of the social group 24 as a timely and targeted incentive to the users 14 of the social group 24. The social network 12 may also be configured to provide additional services relating to the advertising of the product 38, e.g., providing the ordering and billing infrastructure to allow users 14 to complete purchases of the product 38 from the vendor 40, detecting an action associated with an offer 42 (e.g., the completion of a product review of the product 38 by a user 14 of the social group 24 after purchasing), and presenting a reward associated with the offer 42 (e.g., processing a rebate and crediting the user 14.) By detecting the user interest of social groups 24 in various products 38 and presenting the offers 42 to the users 14 of the social groups 24, the social network 12 may facilitate the targeted advertising of the products 38 on behalf of the vendors 40, and may provide a valuable commercial service to the users 14 of the social network 12.

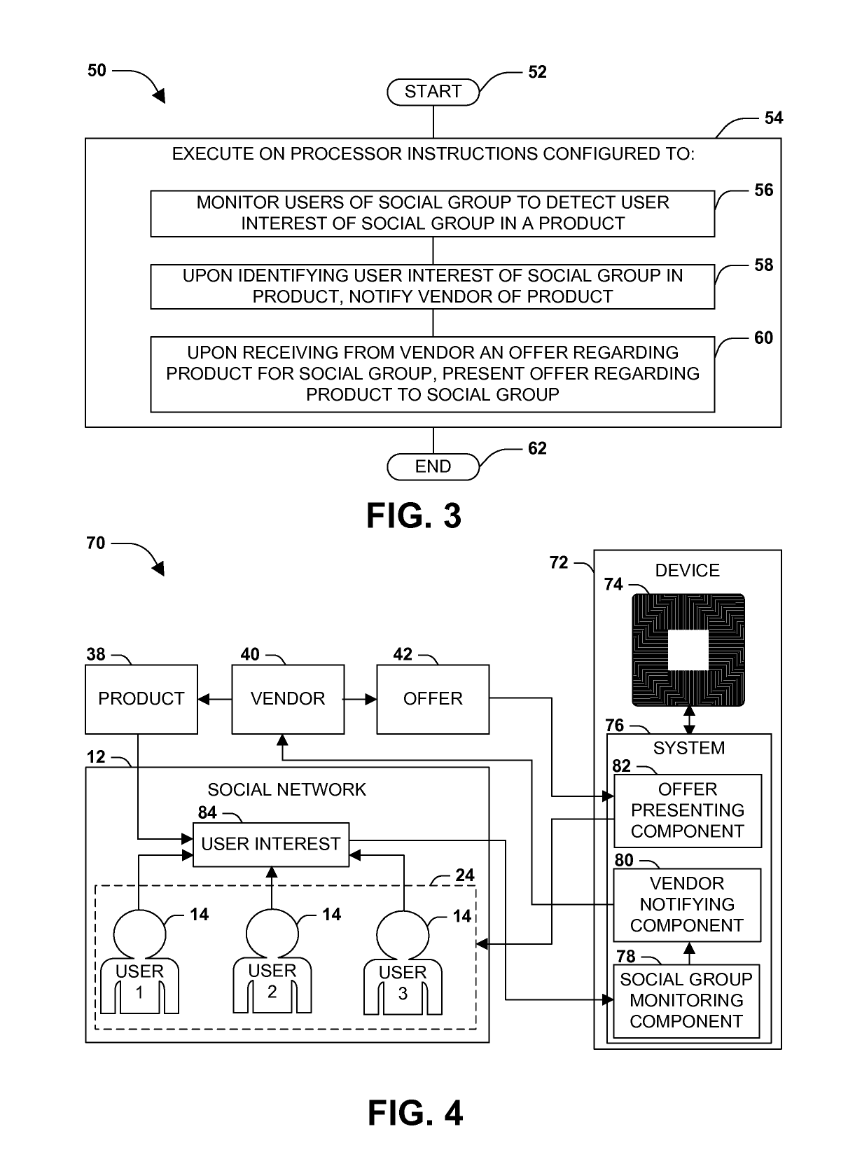

FIG. 3 presents a first embodiment of these techniques, illustrated as an exemplary method 50 of promoting a product 38 to a social group 24 comprising at least two users 14 of a social network 12. The exemplary method 50 may comprise, e.g., software instructions stored on a volatile or non-volatile memory (e.g., system memory, a hard disk drive, a solid state storage device, or a magnetic or optical disc) of a device having a processor. The exemplary method 50 begins at 52 and involves executing 54 on the processor instructions configured to perform the techniques presented herein. In particular, the instructions are configured to monitor 56 the users 14 of the social group 24 to detect a user interest of the social group 24 in a product 38. The instructions are also configured to, upon identifying a user interest of the social group 24 in the product 38, notify 58 a vendor 40 of the product 38 of the detected user interest. The instructions are also configured to, upon receiving from the vendor 40 an offer 42 regarding the product 38 for the social group 24, present 60 the offer 42 regarding the product 38 to the social group 24. Having presented to the users 14 of the social group 24 interested in the product 38 an offer 42 from the vendor 40 relating to the product 38, the exemplary method 50 facilitates the promotion via targeted advertising of the product 38 to the users 14, and so ends at 62.

FIG. 4 presents a second embodiment of these techniques, illustrated as an exemplary system 76 configured to promote a product 38 of a vendor 40 to a social group 24 comprising at least two users 14 of a social network 12. The exemplary system 76 may comprise, e.g., a software architecture comprising a set of interoperating components that, when executed on a processor 74 of a device 72, perform the techniques presented herein. The exemplary system 76 comprises a social group monitoring component 78, which is configured to monitor the users 14 of the social group 24 to detect a user interest 84 of the social group 24 in a product 38. The exemplary system 76 also comprises a vendor notifying component 80, which is configured to, upon the social group monitoring component 78 identifying a user interest 84 of the social group 24 in the product 38, notify a vendor 40 of the product 38 of the detected user interest 84 within the social group 24. The exemplary system 76 also comprises an offer presenting component 82, which is configured to, upon receiving from the vendor 40 an offer 42 regarding the product 38 for the social group 24, present the offer 42 regarding the product 38 to the social group 24. Having presented to the users 14 of the social group 24 interested in the product 38 an offer 42 from the vendor 40 relating to the product 38, the exemplary system 76 facilitates the promotion via targeted advertising of the product 38 to the users 14 of the social group 24.

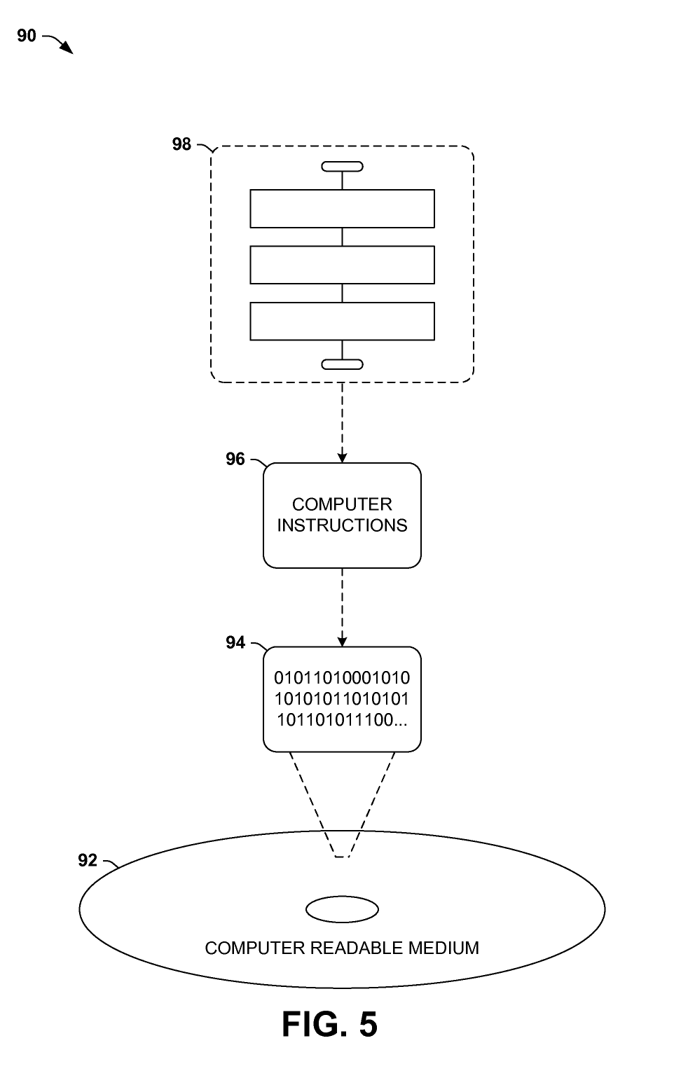

Still another embodiment involves a computer-readable medium comprising processor-executable instructions configured to apply the techniques presented herein. An exemplary computer-readable medium that may be devised in these ways is illustrated in FIG. 5, wherein the implementation 90 comprises a computer-readable medium 92 (e.g., a CD-R, DVD-R, or a platter of a hard disk drive), on which is encoded computer-readable data 94. This computer-readable data 94 in turn comprises a set of computer instructions 96 configured to operate according to the principles set forth herein. In one such embodiment, the processor-executable instructions 96 may be configured to perform a method of promoting a product to a social group comprising at least two users of a social network, such as the exemplary method 50 of FIG. 3. In another such embodiment, the processor-executable instructions 96 may be configured to implement a system for promoting a product to a social group comprising at least two users of a social network, such as the exemplary system 76 of FIG. 4. Some embodiments of this computer-readable medium may comprise a non-transitory computer-readable storage medium (e.g., a hard disk drive, an optical disc, or a flash memory device) that is configured to store processor-executable instructions configured in this manner. Many such computer-readable media may be devised by those of ordinary skill in the art that are configured to operate in accordance with the techniques presented herein.

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the exemplary method 50 of FIG. 3 and the exemplary system 76 of FIG. 4) to confer individual and/or synergistic advantages upon such embodiments.

A first aspect that may vary among embodiments of these techniques relates to the scenarios wherein such techniques may be utilized. A first aspect that may vary among embodiments of these techniques relates to the scenarios wherein these techniques may be utilized. As a first example, these techniques may be utilized within many types of social networks 12 hosting many types of users 14, such as a genealogy social network configured to track families, a friendship social network configured to track friends, an academic or professional social network configured to track scholastic or business contacts, a dating social network configured to perform matchmaking services, and a gaming social network configured to connect users to instances of multiplayer games. As a second example of this first aspect, these techniques may be applied to promote many types of products 38 within many product areas 36 and offered by many types of vendors 40, such as manufactured, cultivated, or discovered articles; media items, such as movies; and tangible services (such as manufacturing or repairing an article) and intangible services (such as teaching a subject.) Those of ordinary skill in the art may devise many such scenarios wherein these techniques may be utilized.

A second aspect that may vary among embodiments of these techniques relates to the architecture of the embodiment. As a first example, an embodiment of these techniques may be implemented within the social network 12, or by a vendor 40 of one or more products 38 that interfaces with the social network 12, or by an independent service that interfaces with both the social network 12 and a set of vendors 40. As a second example of this second aspect, while FIG. 3 illustrates one exemplary method 50 embodying the techniques presented herein, other methods may embody the techniques through a different number or combination of elements; e.g., instead of notifying 58 a vendor 40 after detecting user interest 84 in a product 38 by a social group 24, an exemplary embodiment may involve receiving and storing a set of offers 42 for various products 38 provided by various vendors 40 that may be provided to a social group 24 upon identifying a user interest 84 thereamong. As a third example of this second aspect, while FIG. 4 illustrates one exemplary system 76 embodying the techniques presented herein, other systems may embody the techniques through a different number or combination of elements; e.g., the vendor notifying component 80 may be and the offer presenting component 82 may be implemented as one component. Those of ordinary skill in the art may devise many architectures while designing embodiments of the techniques presented herein.

A third aspect that may vary among embodiments of these techniques relates to the manner of detecting user interest 84 in a product 38 among the users 14 of a social group 24 by monitoring the activities of the users 14. As a first example, an embodiment of these techniques may detect the user interest 84 by monitoring various messages 22 generated by such users 14, such as personal messages 22 sent by a first user 14 to a second user 14, status messages 22 generated by a user 14 and accessible by many other users 14, and comments comprising various conversations 32 among two or more users 14 of the social network 24. As a second example of this third aspect, an embodiment of these techniques may detect the user interest 84 by monitoring search queries 34 submitted by the users 14 of a social group 24 that are associated with the product 38 or the product area 36, which may indicate a user interest 84 of the user 14 that may be shared with other users 14 of the social group 24, or research into the product 38 by the user 14 on behalf of the other users 14 of the social group 24. As a third example of this third aspect, an embodiment of these techniques may detect the user interest 84 by monitoring user reviews generated by the users 14 of the social group 24 regarding the product 38 or the product area 36 containing the product 38; if the user review comprises a positive user review of the product 38, the user 14 (and possibly other users 14 of the social group 24) may have a user interest 84 in the product 38, and may be induced to purchase the product 38 through targeted advertising for the product 38, or, if the user 14 has already purchased the product 38, to promote the product 38 to other users 14 of the social group 24. As a fourth example of this third aspect, the social group 24 may solicit offers for a specific product 38, or for products 38 within a product area 36, and an embodiment of these techniques may be configured to detect the user interest 84 by receiving the solicitation from the social group 24 and sending the solicitation to the vendors 40 of the products 38. As a fifth example of this third aspect, the embodiment may detect a potential user interest 84 among the users 14 of the social group 24, such as a strong interest shared among the users 14 of the social group 24 in the products 38 of the vendor 40, that, even in the absence of detected expressions of user interest 84 in the product 38, may indicate a latent user interest 84 in the product 38, and that may indicate an opportunity for targeted advertising. Those of ordinary skill in the art may devise many ways of detecting user interest 84 among the users 14 of the social group 24 in the product 38 while implementing the techniques presented herein.

A fourth aspect that may vary among embodiments of these techniques relates to the types of offers 42 for various products 38 that may be provided by vendors 40 and extended to the users 14 of the social group 24. The offer 42 might generally specify an action to be performed by a user 14 of the social network 24 and a reward that the vendor 40 is willing to provide upon performance of the action. As a first example of this fourth aspect, the offer 42 may specify many types of actions, including a purchase of the product 38 by the user 14, a testing of the product 38 by the user 14 in order to induce a subsequent purchase, a promotion of the product 38 by the user 14 to other users 14 of the social group 24, or the posting by the user 14 of a user review of the product 38. For example, the offer 42 may also be redeemable upon a user 14 of the social group 24 influencing a second user 14 of the social group 24 to purchase the product 38, or may be extended to the users 14 of a first social group 24 and may be redeemable when a user 14 of the first social group 24 influences a user 14 of a second social group 24 regarding the product 38.

As a second example of this fourth aspect, many types of rewards may be offered by the vendor 40 in response to the action specified in the offer 42. For example, where the action of the offer 42 involves a purchase by the user 14 of the product 38, the reward may involve a reduced price for the product 38, such as a discount or a post-purchase rebate. The reward may also comprise the sale of an improved version of the product, such as a later model with additional features; a free inclusion or a discount on associated products 38, such as peripheral devices, accessories (e.g., printer toner or paper offered with a printer); or an extension or discount on a warranty for the product 38. The reward might also comprise an award of virtual currency, which may be redeemable for value within the social network 12.

As a third example of this fourth aspect, many types of conditions may be placed on the offer 42, either to limit the scope of the offer 42 to a particular set of users 14 or to encourage the users 14 the accept the offer 42. For example, the offer 42 may be limited to the users 14 of the social group 24, and may not be redeemable by users 14 outside of the social group 24, in order to make the offer 42 appear exclusive and of higher value. As one variation, the offer 42 may be extendable by the users 14 of the social group 24 to at least one user 14 outside the social group 24. As another example, the offer 24 may only be valid for a limited time, thus encouraging users 14 to take advantage of the offer 24 prior to its expiration.

As a fourth example of this fourth aspect, the offer 42 may encourage a set of users 14 of a social group 24 to take action regarding a product 38. As a first example, the offer 42 may be redeemable when two or more users 14 of the social group 24 purchase the product 38, e.g., a discount on a bulk purchase of the product 38 by several users 14 of the social group 24. As a second example, the offer 42 may involve increasing rewards for additional actions among the users 14 of the social group 24. For example, when a first user 14 influences a second user 14 to purchase the product 38, the first user 14 may receive a first reward, and when the second user 14 subsequently influences a third user 14 to purchase the product 38, the first user 14 may receive a second reward, as well as the second user 14 receiving a third reward. This type of offer 42 may encourage the cooperative promotion of the product 24 by several users 14 of the social group 24, and may particularly encourage “early adopters” who are the first members of the social group 24 to try, purchase, and/or promote the product 38.

As a fifth example of this fourth aspect, in addition to receiving an offer 42 from the vendor 40 and presenting the offer 42 to the users 14, the social network 12 may provide additional services relating to the offer 42 and the product 38. For example, in addition to notifying the users 14 of the availability of the offer 42, the social network 12 may provide e-commerce infrastructure to permit users 14 to complete transactions relating to the product 38. The social network 12 may also notify the vendor 40 of the actions of the users 14 relating to the product 38 and the offer 42, such as a purchase of the product 38 or the promotion of the product 38 to other users 14. The social network 12 may also facilitate the completion of the offer 42, e.g., by delivering a reward (such as an award of cash or virtual currency) to the users 14.

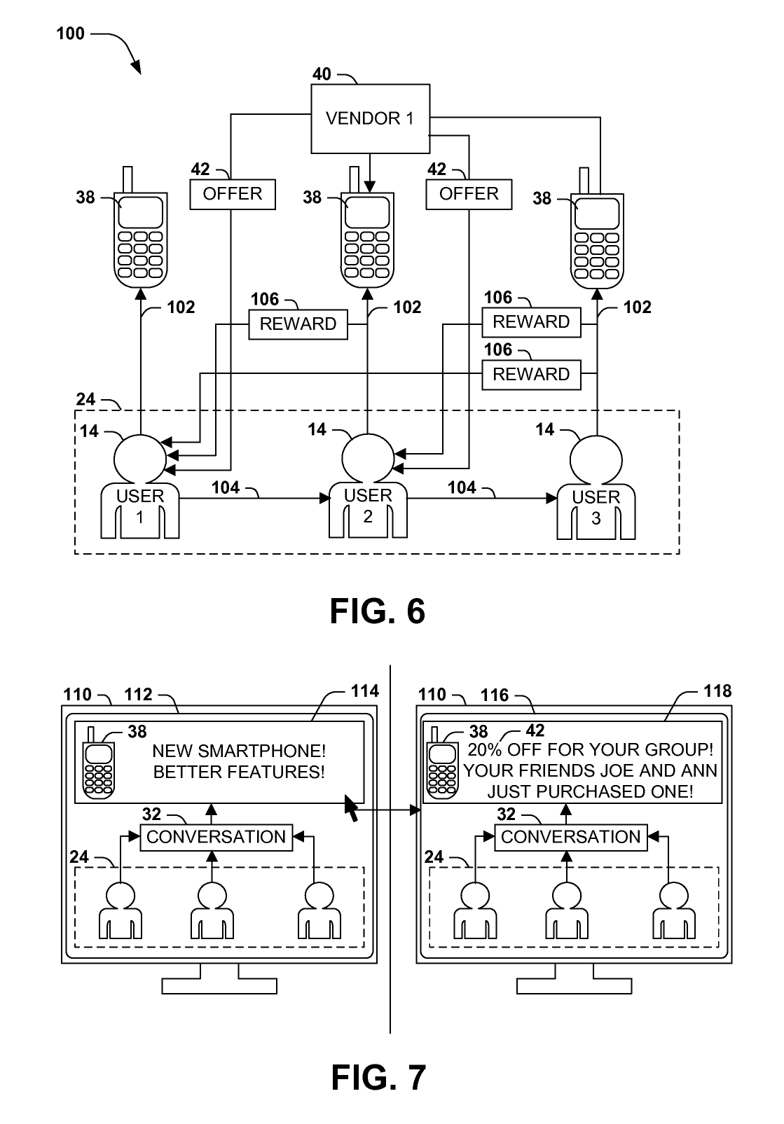

FIG. 6 presents an exemplary scenario 100 featuring a promotion of a product 38 of a vendor 40 to a set of users 14 of a social network 24. In this exemplary scenario 100, when a first user 14 of the social group 24 completes a purchase 102 of the product 38, the vendor 40 may detect that the user 14 is the first member of the social group 24 to purchase the product 38, and may extend to the first user 14 an offer 42 that rewards the first user 14 for the promotion of the product 38 within the social group 24. When the first user 14 influences 104 a second user 14 of the social group 24 regarding the product 38, thereby causing the second user 14 to complete a purchase 102 of the product 38, the vendor 40 may present to the first user 14 a first reward 106, such as a cash bonus or a discount on related products or accessories for the product 38. Moreover, when the second user 14 influences 104 a third user 141 of the social group, resulting in the third user 14 completing a purchase 102 of the product 38, the vendor 40 may, pursuant to the offer 42, extend a second reward 106 to the first user 14, as well as extending a third reward 106 to the third user 14. In this manner, the offer 42 of the vendor 40 may encourage the first user 14 in the initial purchase of the product 38 as an early adopter, as well as the promotion of the product 38 by the first user 14 within the social group 24. Moreover, the social network 12 may, in addition to Those of ordinary skill in the art may devise many types of offers 42 that may be extended to users 14 of social groups 24 of the social network 12 in accordance with the techniques presented herein.

A fifth aspect that may vary among embodiments of these techniques relates to the presentation of the offer 42 to the users 14 of the social network 12. As a first example, when an offer 42 is extended by a vendor 40 to the social group 24, the users 14 of the social group 24 may be notified, e.g., by sending messages to the users 14 on behalf of the vendor 40 that describe the offer 42. As a second example of this fifth aspect, the social network 12 may present the offer 42 to the users 14 upon taking actions involving the social group 24, e.g., upon viewing any conversation 32 among the users 14 of the social group 24. As a third example of this fifth aspect, the social network 12 may present the offer 42 to the users 14 in the context of information about the product 38, e.g., while the user 14 is viewing a product review of the product 38. As a fourth example of this fifth aspect, the social network 12 may permit a user 14 to request to view all of the offers 42 for various products 38 extended by various vendors 40 to the users 14 of the social group 24. This presentation may also be filtered upon the request of the user 14, e.g., to show only offers 42 by a particular vendor 40, or only offers 42 relating to the products 38 within a particular product area 36. As a fifth example of this fifth aspect, the offer 42 may be presented to a user 14 after the user 14 has completed a purchase 102 of the product 38 (e.g., an offer 42 for a post-purchase rebate, an extension of a warranty, or a product accessory in exchange for a posting by the user 14 of a product review of the product 38 may be presented to the user at the conclusion of the purchase transaction.)

As a fifth example of this fifth aspect, the offer 42 may be presented to the user 14 in conjunction with an ordinary advertisement for the product 38; e.g., the advertisement may be customized with information pertinent to the user 14, the social group 24, and/or the offer 42. This customization might be performed for advertisements displayed outside of the social network 12; e.g., a user 14 may register with a social network 12 through a persistent set of login credentials, such as an OpenID profile, and a website outside of the social network 14 may, upon displaying an advertisement for the product 38, utilize the OpenID profile of the user 14 to identify the social groups 24 that include the user 14 and to display offers 42 extended to these social groups 24. The presentation of the offer 42 may also be customized in other ways, e.g., by displaying the number or names of other users 14 of the social group 24 who have redeemed the offer 42 and/or purchased the product 38. As a sixth example of this fifth aspect, when a first user 14 of the social group 24 redeems the offer 42 (e.g., when the social network 12 detects an offer redemption of the offer 42), other users 14 of the social group 24 may be spontaneously notified of the offer redemption by the first user 14.

FIG. 7 presents an illustration of an exemplary scenario featuring a presentation of an offer 42 regarding a product 38 to a set of users 14 of a social group 24. In this exemplary scenario, a user 14 of the social network 12 may request to view a conversation 32 among the members of the social group 24 about a product 38, and the social network 14 may present with the conversation 32 (e.g., on a display component 110 of a device operated by the user 14) a first presentation 112 including a general advertisement 114 for the product 38. However, if the user 14 interacts with the general advertisement 114 (e.g., by clicking on the general advertisement 114 or hovering on the general advertisement 114 with a pointer), the social network 12 may generate and deliver to the user (for rendering on the display component 110 of the device) a second presentation 116 featuring a customized advertisement 118 that displays the offer 42 extended to the users 14 of the social group 24. Moreover, the customized advertisement 118 may indicate the names of other users 14 of the social group 24 that have redeemed the offer 42, thereby encouraging the user 14 to follow the actions of his or her friends in purchasing the product 38. In this manner, the social network 12 may promote the targeted advertising of the product 38 to the user 14 through the presentation of a customized advertisement 118 including the offer 42 extended to the social group 24 of the user 14. Those of ordinary skill in the art may devise many ways of presenting 60 an offer 42 to the users 14 of a social group 24 while implementing the techniques presented herein.

A sixth aspect that may vary among embodiments of these techniques relates to additional features that may be included in the social network 14 relating to the extension of an offer 42 for a product 38 to the users 14 of a social group 24. As a first example, a user 14 of the social network 12 may be interested in redeeming an offer 42 for a product 38, but may have been extended several offers 42 for the product 38, and may have difficulty choosing among the offers 42. For example, the user 14 may be a member of many social groups 24 to which offers 42 have been extended, and the offers 42 may differ in redeeming actions and rewards. The social network 12 may assist the user 14 in selecting an offer 42 for the product 38 by comparing the available offers 42 and recommending one that may be appealing to the user 14. This recommendation may be based on the cost savings to the user 14 in purchasing the product 38 under different offers 42, but may also involve other considerations, e.g., the comparative value of product accessories included with the product 38 through various offers 42, the total savings to all members of a social group 24, and a comparative preference of the user 14 for a point-of-sale discount than a delayed post-sale rebate (such as a mail-in rebate.)

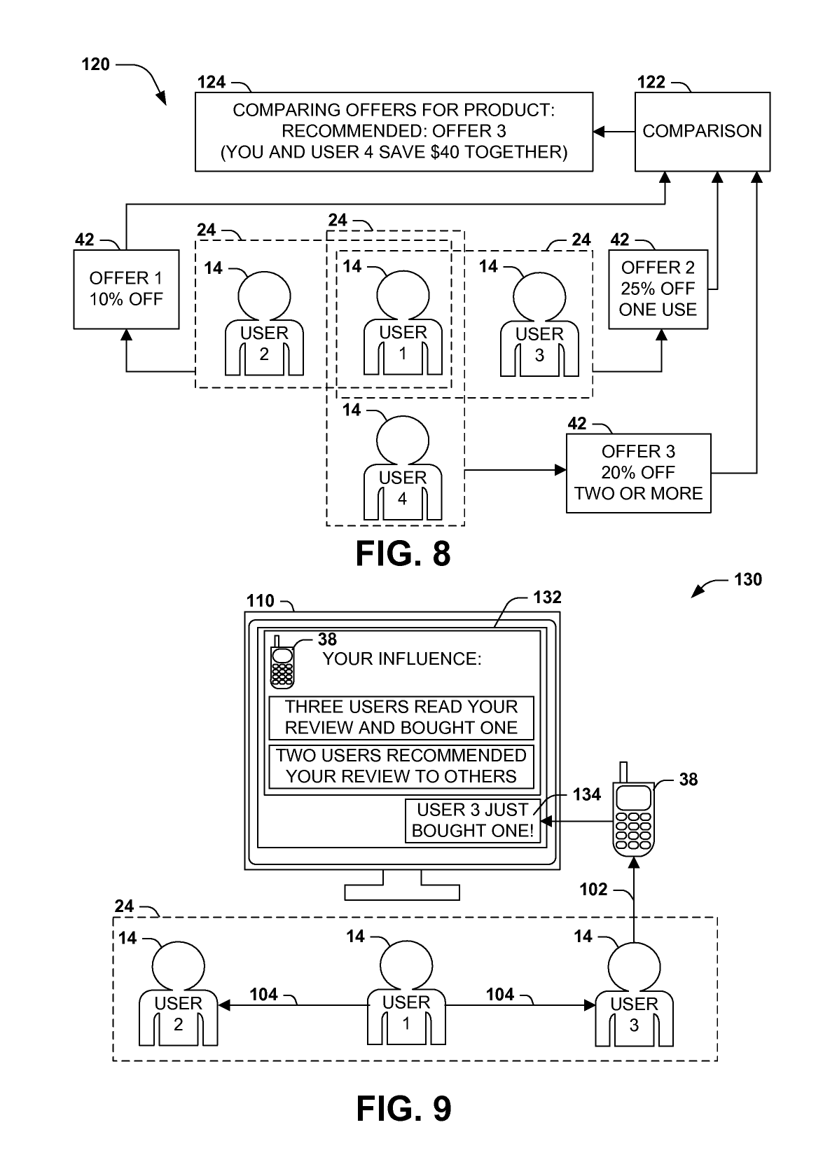

FIG. 8 presents an illustration of an exemplary scenario 120 featuring a first user 14 who may wish to purchase a product 38 using one of several offers 42 that may be available. In this exemplary scenario 120, the first user 14 is a member of three social groups 24, and a vendor 40 of a product 38 may have extended a different offer to each social group 24. A first offer 42 may present a 10% discount on the price of the product 38; a second offer 42 may present a 25% discount on the price of the same product 38 for the first purchaser of the product 38 among the users 14 of the social group 24; and a third offer 42 may present a 20% price discount for each user 14 of the social group 24 who purchases the product 24. The user 14 may have difficulty selecting among the offers 42, and may ask the social network 12 to recommend an offer 42. Accordingly, the social network 12 may perform a comparison 122 of the conditions of each offer 42, and may provide an offer recommendation 124 of a particular offer 42 for the product 24. In this exemplary scenario, the social network 12 presents an offer recommendation 124 for the third offer 42, because, while the second offer 42 may present a higher cost savings for the user 14 (e.g., a $25 savings on a $100 product 38), the third offer may present a higher combined cost savings for all users 14 of the social group 24 (e.g., a $40 savings on two purchases of the $100 product 38.)

As a second example of this sixth aspect, an embodiment of these techniques may be configured to track the influence of users 14 on other users 14, such as the influential effects of the comments of the user 14 and the persuasiveness of product reviews of various products 38. This tracking may be achieved by evaluating the actions of a second user 14 (e.g., the actions of the second user 14 in reading a product review of a product 38, in rating the persuasiveness of a product review of a product 38, in reposting or referencing a comment or product review of a product 38, in choosing among products 38 in a product area 36, and in purchasing a product 38), and then identifying the actions of a first user that influenced the actions of the second user 14. This tracking may be useful, e.g., to notify the user 14 as to the effectiveness of his or her actions, such as by notifying a first user 14 when a second user 14 exhibits a user influence, such as purchasing the product 38, based on the actions of the first user 14. A user 14 may request to view an influence profile that indicates the effectiveness of the actions of the user 14 (e.g., the detected influence of the user's comments, recommendations, and product reviews on other users 14 of the social network 12, and the social network 12 may prepare and present to the user 14 an influence profile that indicates the influence of the user 14. This tracking may also be useful to identify influential users 14 who may be able to influence other users 14, and who therefore may be an appealing target for advertising (e.g., by offering a product 38 to the influential user 14 at a discount, the vendor 40 may be able to obtain an independent and persuasive product review that may improve sales of the product 38 to other users 14.)

FIG. 9 presents an exemplary scenario 130 featuring the tracking of influence 14 of a user 14 on other users 14 of a social group 24 within a social network 12. The social network 12 may track the influence of the first user 14, and, upon a request of the first user 14, may present (e.g., on a display component 110 of a device operated by the first user 14) an influence profile 132 indicating the influence of the first user 14 on other users 14 regarding a product 38, such as the number of people who purchased a product 38 after reading a user review of the product 38 written by the first user 14, and the number of recommendations of the product review to other users 14. The social network 12 may also actively notify the user 14 of such influence; e.g., if the third user 14 of the social group 24 completes a purchase 102 of the product 38 in response to the influence 104 of the first user 14, the social network may present to the first user 14 a notification 134 of the influence of the first user 14. In this manner, the social network 12 may track the influence of the first user 14, and may notify the first user 14 of his or her influence, in order to encourage the first user 14 to review or promote additional products 38. Those of ordinary skill in the art may devise many such additional features that may be included in embodiments of these techniques.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

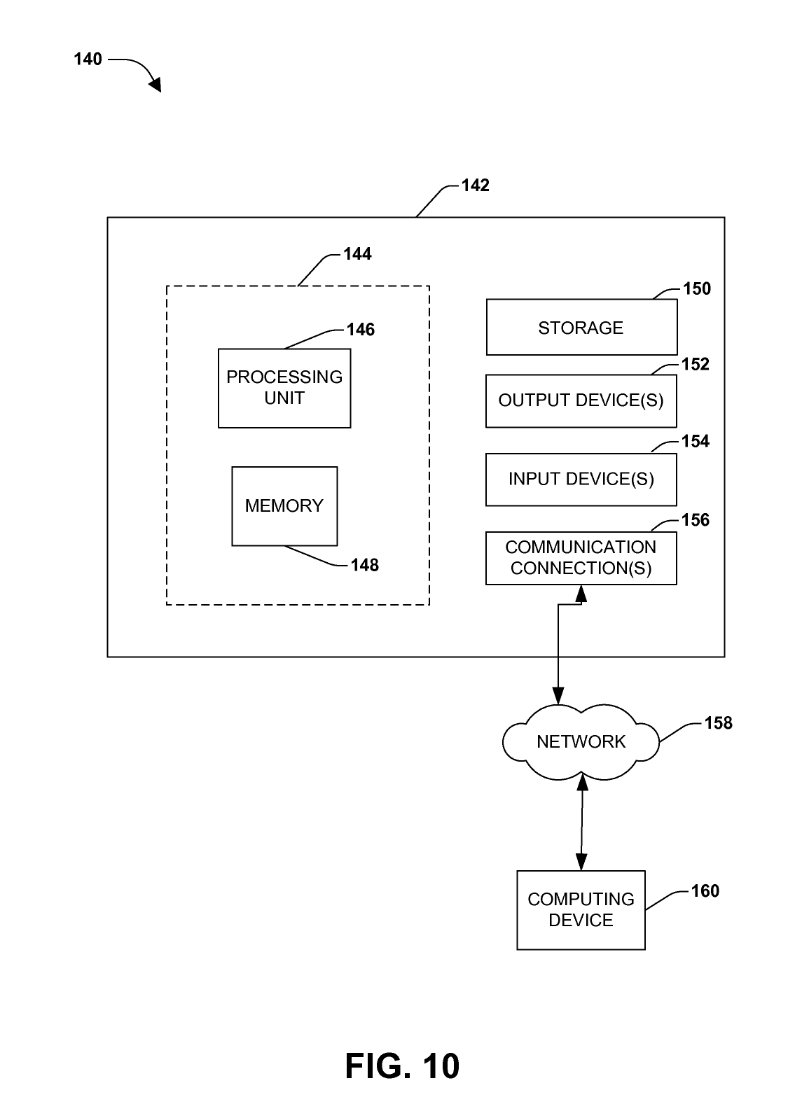

FIG. 10 and the following discussion provide a brief, general description of a suitable computing environment to implement embodiments of one or more of the provisions set forth herein. The operating environment of FIG. 10 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 10 illustrates an example of a system 140 comprising a computing device 142 configured to implement one or more embodiments provided herein. In one configuration, computing device 142 includes at least one processing unit 146 and memory 148. Depending on the exact configuration and type of computing device, memory 148 may be volatile (such as RAM, for example), non-volatile (such as ROM, flash memory, etc., for example) or some combination of the two. This configuration is illustrated in FIG. 10 by dashed line 144.

In other embodiments, device 142 may include additional features and/or functionality. For example, device 142 may also include additional storage (e.g., removable and/or non-removable) including, but not limited to, magnetic storage, optical storage, and the like. Such additional storage is illustrated in FIG. 10 by storage 150. In one embodiment, computer readable instructions to implement one or more embodiments provided herein may be in storage 150. Storage 150 may also store other computer readable instructions to implement an operating system, an application program, and the like. Computer readable instructions may be loaded in memory 148 for execution by processing unit 146, for example.

The term “computer readable media” as used herein includes computer storage media. Computer storage media includes volatile and nonvolatile, removable and non-removable media implemented in any method or technology for storage of information such as computer readable instructions or other data. Memory 148 and storage 150 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 142. Any such computer storage media may be part of device 142.

Device 142 may also include communication connection(s) 156 that allows device 142 to communicate with other devices. Communication connection(s) 156 may include, but is not limited to, a modem, a Network Interface Card (NIC), an integrated network interface, a radio frequency transmitter/receiver, an infrared port, a USB connection, or other interfaces for connecting computing device 142 to other computing devices. Communication connection(s) 156 may include a wired connection or a wireless connection. Communication connection(s) 156 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 142 may include input device(s) 154 such as keyboard, mouse, pen, voice input device, touch input device, infrared cameras, video input devices, and/or any other input device. Output device(s) 152 such as one or more displays, speakers, printers, and/or any other output device may also be included in device 142. Input device(s) 154 and output device(s) 152 may be connected to device 142 via a wired connection, wireless connection, or any combination thereof. In one embodiment, an input device or an output device from another computing device may be used as input device(s) 154 or output device(s) 152 for computing device 142.

Components of computing device 142 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 142 may be interconnected by a network. For example, memory 148 may be comprised of multiple physical memory units located in different physical locations interconnected by a network.

Those skilled in the art will realize that storage devices utilized to store computer readable instructions may be distributed across a network. For example, a computing device 160 accessible via network 158 may store computer readable instructions to implement one or more embodiments provided herein. Computing device 142 may access computing device 160 and download a part or all of the computer readable instructions for execution. Alternatively, computing device 142 may download pieces of the computer readable instructions, as needed, or some instructions may be executed at computing device 142 and some at computing device 160.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of promoting a product to a social group comprising at least two users of a social network on a device having a processor, the method comprising:
executing on the processor instructions configured to:
monitor the users of the social group to detect a user interest of the social group in a product;
upon identifying a user interest of the social group in the product, notify a vendor of the product; and
upon receiving from the vendor an offer regarding the product for the social group, present the offer regarding the product to the social group.

2. The method of claim 1, detecting the user interest comprising: detecting at least one search query associated with the product and submitted by a user of the social group.

3. The method of claim 1, detecting the user interest comprising: detecting at least one positive user review of the product submitted by at least one user of the social group.

4. The method of claim 1, detecting the user interest comprising: receiving from the social group an offer solicitation of an offer from the vendor regarding the product.

5. The method of claim 1:
the offer comprising an action and a reward; and
the instructions configured to, upon detecting an instance of the action by a user, present the reward to the user.

6. The method of claim 1, the offer redeemable upon a purchase of the product by at least two users of the social group.

7. The method of claim 1, the offer redeemable upon a user of the social group influencing a second user of the social group regarding the product.

8. The method of claim 1, the offer limited to the users of the social group.

9. The method of claim 8, the offer extendable by the users of the social group to at least one user outside the social group.

10. The method of claim 1:
at least one user of the social group also included in a second social group; and
the offer redeemable upon a user of the social group influencing another user of the second social group regarding the product.

11. The method of claim 1, the offer comprising:
a first reward presented to the first user upon the first user influencing a second user of the social network regarding the product;
a second reward presented to the first user upon the second user influencing a third user of the social network regarding the product; and
a third reward presented to the second user upon the second user influencing the third user of the social network regarding the product.

12. The method of claim 1, presenting the offer comprising: presenting the offer associated with an advertisement for the product viewed by a user of the social group.

13. The method of claim 1, presenting the offer comprising: presenting the offer associated with a product review of the product viewed by a user of the social group.

14. The method of claim 1, presenting the offer comprising: presenting the offer to a user after a purchase of the product by the user.

15. The method of claim 1, the instructions configured to, upon detecting an offer redemption of the offer by a first user of the social group, notify a second user of the social group of the offer redemption of the offer by the first user.

16. The method of claim 1, the instructions configured to, upon receiving a product offer comparison request from a user to compare at least two offers to the user regarding a product:
among the at least two offers to the user, select a recommended offer, and
present the recommended offer to the user.

17. The method of claim 1, the instructions configured to, upon detecting a user influence of a first user on a second user regarding a product, notify the first user.

18. The method of claim 1, the instructions configured to:
upon detecting a user influence of a first user on a second user regarding a product, record the user influence of the first user on the second user; and
upon receiving a request from the first user to present a user influence profile:
retrieve recorded user influences of the first user on other users, and
present the recorded user influences to the first user.

19. A system configured to promote a product to a social group comprising at least two users of a social network, the system comprising:
a social group monitoring component configured to monitor the users of the social group to detect a user interest of the social group in a product;
a vendor notifying component configured to, upon the social group monitoring component identifying a user interest of the social group in the product, notify a vendor of the product; and
an offer presenting component configured to, upon receiving from the vendor an offer regarding the product for the social group, present the offer regarding the product to the social group.

20. A computer-readable storage medium comprising instructions that, when executed on a processor of a device, promote a product to a social group comprising at least two users of a social network by:
monitoring the users of the social group to detect a user interest of the social group in a product, comprising at least one of:
at least one positive user review of the product submitted by at least one user of the social group;
at least one search query associated with the product and submitted by a user of the social group; and
an offer solicitation received from the group for an offer from the vendor regarding the product;
upon identifying a user interest of the social group in the product, notifying a vendor of the product;
upon receiving from the vendor an offer regarding the product for the social group, the offer comprising an action and a reward, the offer limited to the users of the social group and extendable by the users of the social group to at least one user outside the social group:
presenting the offer associated with an advertisement for the product viewed by a user of the social group;
presenting the offer associated with a product review of the product viewed by a user of the social group;
upon detecting an offer redemption of the offer by a first user of the social group, notifying a second user of the social group of the offer redemption of the offer by the first user;
upon detecting an instance of the action by a user, presenting the reward to the user;
upon receiving a product offer comparison request from a user to compare at least two offers to the user regarding a product:
among the at least two offers to the user, selecting a recommended offer, and
presenting the recommended offer to the user;
upon detecting a user influence of a first user on a second user regarding a product, recording the user influence of the first user on the second user; and
upon receiving a request from the first user to present a user influence profile:
retrieving recorded user influences of the first user on other users, and
presenting the recorded user influences to the first user.
